(19) United States
(12) Patent Application Publication
(10) Pub. No.: US 2023/0328727 A1
(43) Pub. Date: Oct. 12, 2023

(54) URLLC Enhancement On Unlicensed Spectrum In Mobile Communications

(71) Applicant: MediaTek Singapore Pte. Ltd., Singapore (SG)

(72) Inventors: Abdellatif Salah, Cambridge (GB); Mohammed S Aleabe Al-Imari, Cambridge (GB); Jozsef Gabor Nemeth, Cambridge (GB)

(21) Appl. No.: 18/015,954

(22) PCT Filed: Jul. 15, 2021
(86) PCT No.: PCT/CN2021/106411

§ 371 Date: Jan. 12, 2023

Related U.S. Application Data
(60) Provisional application No. 63/051,936, filed on Jul. 15, 2020.

(51) Int. Cl. H04W 72/1273; H04W 16/14; H04W 72/232; H04L 5/00; H04L 1/1812

(52) U.S. Cl. CPC H04W 72/1273; H04W 16/14; H04W 72/232; H04L 5/0055; H04L 1/1812

(57) ABSTRACT

Various solutions for Ultra-Reliable Low-Latency Communication (URLLC) enhancement on unlicensed spectrum in mobile communications are described. An apparatus, implementable in a UE, determines grouping of a plurality of physical downlink shared channel (PDSCH) receptions scheduled by downlink control information (DCI) formats 1_1 and 1_2 in a same PDSCH group from a network node on a New Radio unlicensed spectrum (NR-U). The apparatus then performs the PDSCH receptions based on the determined grouping.

### CROSS REFERENCE TO RELATED APPLICATIONS

The present disclosure is part of U.S. National Stage filing of International Patent Application No. PCT/CN2021/06411, filed on 15 Jul. 2021, which is part of a non-provisional application claiming the priority benefit of U.S. Patent Application Nos. 63/051,936, filed on 15 Jul. 2020, the content of which being incorporated by reference in its entirety.

### FIELD OF INVENTION

The present disclosure is generally related to mobile communications and, more particularly, to techniques for Ultra-Reliable Low-Latency Communication (URLLC) enhancement on unlicensed spectrum in mobile communications.

### BACKGROUND OF THE INVENTION

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), enhancement for URLLC is required to operate on a NR unlicensed spectrum (NR-U) and co-exist with NR-U features defined in pertinent 3GPP specification(s). Therefore, there is a need for a solution to achieve URLLC enhancement on unlicensed spectrum in mobile communications.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for URLLC enhancement on unlicensed spectrum in mobile communications.

In one aspect, a method may involve a user equipment (UE) communicating with a network node on a NR-U and using a hybrid automatic repeat request (HARQ) procedure. The method may also involve the UE transmitting a physical uplink control channel (PUCCH) in an event that the PUCCH is missed during an original channel occupancy time (COT).

In one aspect, a method may involve a UE communicating with a network node on a NR-U and using a HARQ procedure. The method may also involve the UE receiving a plurality of physical downlink shared channel (PDSCH) groups. Each PDSCH group of the plurality of PDSCH groups may be associated with a respective HARQ acknowledgement (HARQ-ACK) codebook. Each priority level of a plurality of priority levels may correspond to respective two PDSCH groups of the plurality of PDSCH groups.

In one aspect, a method may involve a UE determining grouping of a plurality of PDSCH receptions scheduled by downlink control information (DCI) formats 1_1 and 1_2 in a same PDSCH group from a network node on a NR-U. The method may also involve the UE performing the PDSCH receptions based on the determined grouping.

In one aspect, a method may involve a UE communicating with a network node on a NR-U and using a HARQ procedure. The method may also involve the UE generating a first HARQ-ACK codebook corresponding to a non-scheduled group and a second HARQ-ACK codebook corresponding to a scheduled group. The method may further involve the UE transmitting either the first HARQ-ACK codebook or the second HARQ-ACK codebook in a PUCCH occasion based on a respective priority of each of the first HARQ-ACK codebook and the second HARQ-ACK codebook.

In one aspect, a method may involve a UE receiving from a network node a one-shot HARQ-ACK feedback request in a DCI format 1_2. The method may also involve the UE transmitting, in a PUCCH occasion, a HARQ-ACK feedback containing all configured HARQ processes associated with one or more requested cells.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example scenario under a proposed scheme in accordance with the present disclosure.

FIG. 9 is a block diagram of an example communication apparatus and an example network apparatus in accordance with an implementation of the present disclosure.

FIG. 10 is a flowchart of an example process in accordance with an implementation of the present disclosure.

FIG. 11 is a flowchart of an example process in accordance with an implementation of the present disclosure.

FIG. 12 is a flowchart of an example process in accordance with an implementation of the present disclosure.

FIG. 13 is a flowchart of an example process in accordance with an implementation of the present disclosure.

FIG. 14 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to URLLC enhancement on unlicensed spectrum in mobile communications. According to the present disclosure, a number of possible solutions may be implemented separately or jointly. That is, although these possible solutions may be described below separately, two or more of these possible solutions may be implemented in one combination or another.

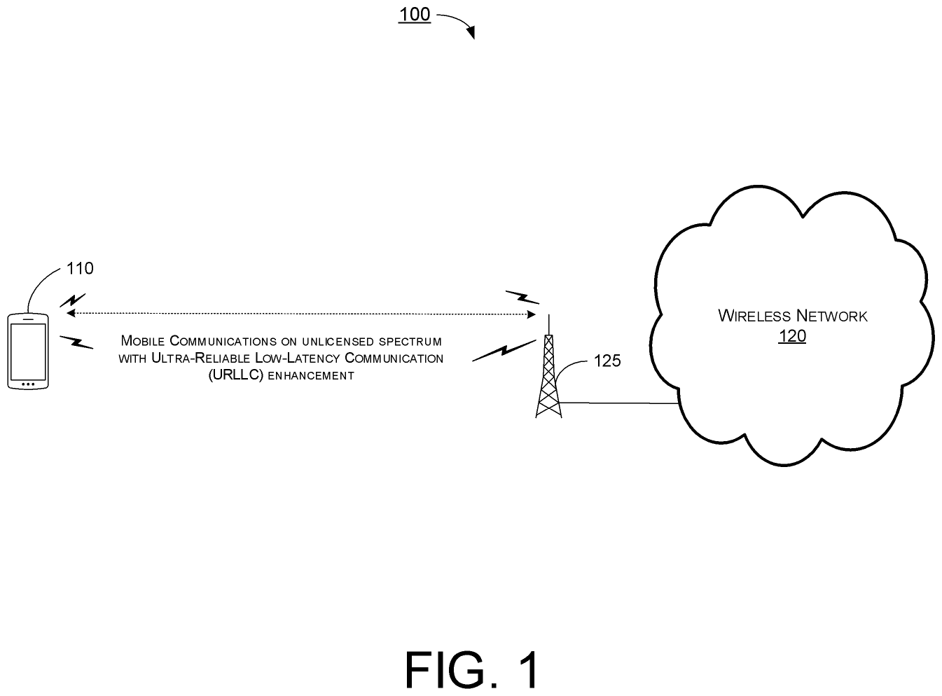

FIG. 1 illustrates an example network environment 100 in which various solutions and schemes in accordance with the present disclosure may be implemented. Referring to FIG. 1, network environment 100 may involve a user equipment (UE) 110 in wireless communication with a wireless network 120 (e.g., a 5G NR mobile network or another type of network such as an NTN). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to URLLC enhancement on unlicensed spectrum in mobile communications, as described below.

In Release 16 (Rel-16) of the 3GPP specification, essential enhancements to HARQ for NR-U were introduced. Specifically, with respect to HARQ-ACK retransmission design, enhanced dynamic HARQ-ACK codebook (enhanced Type-2 codebook) is introduced in Rel-16 and allows for DCI to trigger HARQ-ACK retransmission using dynamic PDSCH grouping. However, there are certain latency and reliability issues regarding HARQ-ACK retransmission design in NR-U.

With respect to latency, in case a PUCCH occasion is blocked by listen-before-talk (LBT) failure or detection error, a new PUCCH is triggered in a subsequent COT to carry the HARQ-ACK codebook missed in the previous COT. A new PDSCH scheduling is required in the new COT for UE 110 to know which slot (K1) is to be used for PUCCH retransmission. However, this requires network node 125 to schedule PDSCH (even if no data available) and for UE 110 to decode it before being able to perform any PUCCH retransmission. Consequently, this design would cause additional latency and could impact service in case the missed PUCCH is related to an URLLC traffic. With respect to reliability, HARQ-ACK from a previous COT could not be transmitted alone and would need to be concatenated with HARQ-ACK of a current COT. Consequently, the resultant large payload could compromise reliability of PUCCH.

Under a first proposed scheme in accordance with the present disclosure with respect to latency and reliability enhancement for NR-U HARQ-ACK retransmission, UE 110 may be configured to transmit the missed PUCCH quickly with one or more options. In a first option (Option 1), UE 110 may be signaled with k1 outside the COT, and UE 110 may use LBT category 4 (higher priority to access channel but for a shorter duration) and attempt to transmit the missed PUCCH. For instance, UE 110 may use high-priority LBT parameters to quickly access the channel. UE 110 may be allocated a very short COT which is acceptable as it is for PUCCH-only transmission. UE 110 may be configured to use these high-priority LBT parameters only for high-priority HARQ-ACK codebook transmission. In a second option (Option 2), UE 110 may use LBT category 4 to access the channel and transmit PUCCH on configured-grant (CG) physical uplink shared channel (PUSCH) resources. Under the proposed scheme, logical channel prioritization (LCP) rules may be utilized to decide when a pending HARQ-ACK codebook may be transmitted over a CG resource. For instance, for certain logical channels multiplexing may be enabled while for other logical channels multiplexing may be disabled. In a third option (Option 3), UE 110 may transmit on PUCCH resources that may be signaled directly in DCI format 2_0 at the start of the new COT, and these resources may be dedicated for the transmission of the missed PUCCH. In a fourth option (Option 4), fixed PUCCH resources at the start of each COT may be dedicated for the transmission of any missed PUCCH in a previous COT. Under the proposed scheme, for each CG resource configuration, network node 125 may configure separately in case a separate COT contains a fixed separate PUCCH resource. The PUCCH may be transmitted even if there is no data to send.

With dynamic PDSCH grouping, each PDSCH group is associated with a respective HARQ-ACK codebook. Up to two PDSCH groups may be used simultaneously. However, two PDSCH groups may not be sufficient when enhanced mobile broadband (eMBB) and URLLC services are operated simultaneously.

Under a second proposed scheme in accordance with the present disclosure with respect to enhancement to dynamic PDSCH grouping, two PDSCH groups may be defined for each priority level. The number of PDSCH groups may be radio resource control (RRC) configurable or specified per HARQ-ACK codebook priority. For instance, three PDSCH groups for high-priority HARQ and one PDSCH group for low-priority HARQ may be configured or specified. Under the proposed scheme, a PDSCH group priority may be introduced under one of several options. In a first option (Option 1), the priority may be the same as the associated HARQ codebook. In a second option (Option 2), the priority may be according to the DCI that schedules the PDSCH. In a third option (Option 3), each PDSCH group associated with a certain priority (e.g., PDSCH Group Index (PGI) 0 associated with low priority and PGI 1 associated with high priority). In a fourth option (Option 4), separately configured priorities for PDSCH groups may be utilized. For instance, when URLLC PDSCH is scheduled towards the end of a COT and there is also an opportunity to send PUCCH just before the end of the COT, while the PUCCH is already reserved by another PDSCH group (PG) for eMBB, then that eMBB PUCCH may be canceled and used for the new URLLC PG instead as URLLC has higher priority than eMBB. The eMBB PUCCH may be postponed to the subsequent COT using its same PGI or using the request feedback technique.

With respect to DCI formats scheduling in a same PDSCH group, UE 110 may determine the grouping for PDSCH receptions scheduled by DCI format 1_1 based on the fields of PGI and New Feedback Indicator (NFI). For PDSCHs in the same group, the corresponding PGI may be the same (e.g., if PDSCHs are indicated with different PGIs, they are in different groups). Thus, two groups may be allowed for downlink (DL) scheduling with one bit for PGI. The NFI field may operate as a toggle bit to reset a respective group. When toggled, the NFI field may indicate that a respective group and its corresponding Downlink Assignment Index (DAI) field are reset. When not toggled, the NFI field may indicate that the respective group and its corresponding DAI are continuously accumulated. For a PDSCH reception scheduled by DCI format 1_0, PGI and NFI are not present. In case UE 110 detects at least one DCI format 1_1 indicating PGI=0 and associated with the same PUCCH occasion according to K1 value, then UE 110 may assume the PDSCH reception scheduled by DCI format 1_0 belongs to group 0 (PGI=0). Additionally, UE 110 may follow the indicated NFI in DCI format 1_1 to determine the codebook for group 0. Otherwise, UE 110 may assume the PDSCH reception does not belong to any group, and UE 110 may follow Release 15 (Rel-15) NR dynamic codebook to determine the codebook for the PDSCH reception.

Under a third proposed scheme in accordance with the present disclosure with respect to DCI formats scheduling in a same PDSCH group, multiple PDSCHs may be scheduled by DCI format 1_1 and format 1_2 in a same PDSCH group. Currently, in Rel-16 of the 3GPP specification, the fallback DCI 1_0 may be used to schedule PDSCH in the same PDSCH group as DCI format 1_1. DCI format 1_2 may be treated as the fallback DCI. However, this may be very restrictive and dependent on DCI format 1_1. Under the proposed scheme, the bit-fields PGI and NFI may be included in DCI format 1_2. Moreover, under the proposed scheme, compact DCI and fallback DCI may be in the same PDSCH group. It is noteworthy that, in case compact DCI is treated as non-fallback DCI format 1_1, then it may be feasible to include compact DCI and fallback DCI may be in the same PDSCH group; otherwise, in case compact DCI is treated as fallback DCI, then it may not be feasible. Furthermore, under the proposed scheme, three DCI formats may be utilized in the same PDSCH group, namely formats 1_0, 1_1 and 1_2.

In a first case (Case 1) under the third proposed scheme, UE 110 may be configured to monitor both DCI formats 1_1 and 1_2 with no physical layer (PHY) priority indication being configured. For a PDSCH scheduled by DCI format 1_2, the PGI for a HARQ feedback in a PUCCH occasion in a slot or sub-slot X may follow the PGI indicated in DCI format 1_1 for the same PUCCH occasion in slot/sub-slot X. In case UE 110 does not detect at least one DCI formats 1_1 indicating PGI=0 or 1 with a PUCCH occasion in slot/sub-slot X, then UE 110 may assume a default PGI. For instance, the default PGI may be 0. Alternatively, the default PGI may be 1. Still alternatively, the default PGI may be configured by higher layers (e.g., as RRC parameters in RRC signaling).

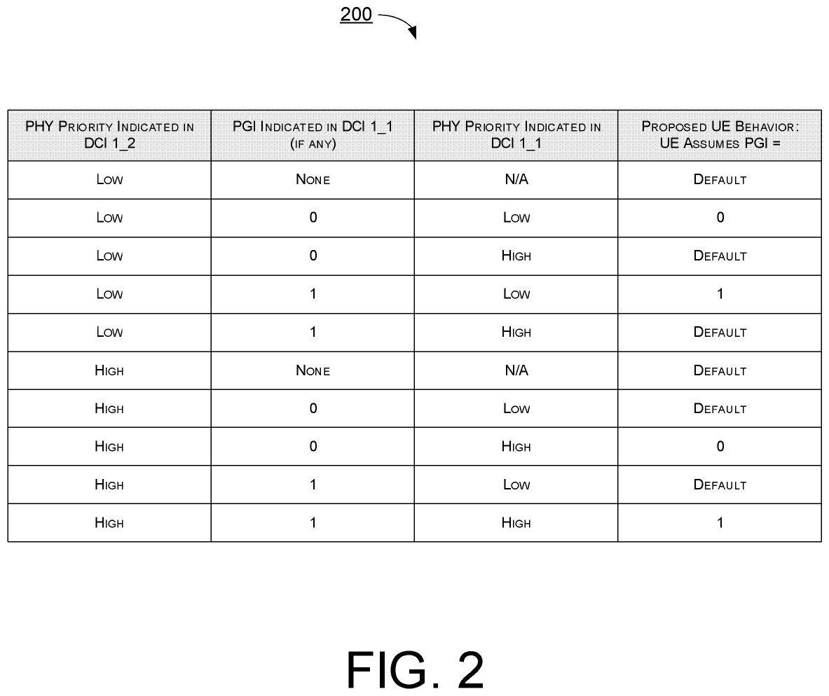

In a second case (Case 2) under the third proposed scheme, UE 110 may be configured to monitor both DCI formats 1_1 and 1_2 with PHY priority indication being configured for both DCIs. For a PDSCH scheduled by DCI format 1_2, the PGI for a HARQ feedback in a PUCCH occasion in slot/sub-slot X with PHY priority Y (low or high) may follow the PGI indicated in DCI format 1_1 for the same PUCCH occasion in slot/sub-slot X and the same PHY priority. In case UE 110 does not detect at least one DCI format 1_1 indicating PGI=0 or 1 with a PUCCH occasion in slot/sub-slot X, then UE 110 may assume a default PGI. In case UE 110 does not detect at least one DCI format 1_1 indicating PGI=0 or 1 with a PUCCH occasion in slot/sub-slot X with PHY priority Y, then UE 110 may assume a default PGI. For instance, the default PGI may be 0. Alternatively, the default PGI may be 1. Still alternatively, the default PGI may be configured by higher layers (e.g., as RRC parameters in RRC signaling). FIG. 2 illustrates an example scenario 200 of UE behavior for indicated PGI and PHY priority in DCI formats 1_1 and 1_2.

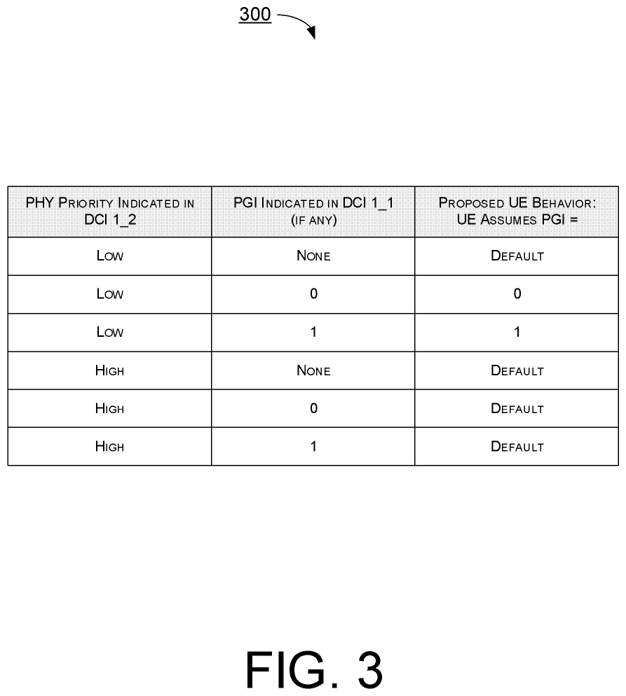

In a third case (Case 3) under the third proposed scheme, UE 110 may be configured to monitor both DCI formats 1_1 and 1_2 with PHY priority indication being configured only in DCI format 1_2. For a PDSCH scheduled by DCI format 1_2, the PGI for a HARQ feedback in a PUCCH occasion in slot/sub-slot X with PHY priority Y (low or high) may follow the PGI indicated in DCI format 1_1 for the same PUCCH occasion in slot/sub-slot X in case the PHY priority indicated in DCI format 1_2 is low. In case UE 110 does not detect at least one DCI format 1_1 indicating PGI =0 or 1 with a PUCCH occasion in slot/sub-slot X, then UE 110 may assume a default PGI. In case the PHY priority in DCI format 1_2 is high, then UE 110 may assume a default PGI. For instance, the default PGI may be 0. Alternatively, the default PGI may be 1. Still alternatively, the default PGI may be configured by higher layers (e.g., as RRC parameters in RRC signaling). In some cases, in case the PHY priority in DCI format 1_2 is high, then UE 110 may utilize another available PGI. FIG. 3 illustrates an example scenario 300 of UE behavior for indicated PGI and PHY priority in DCI format 1_2.

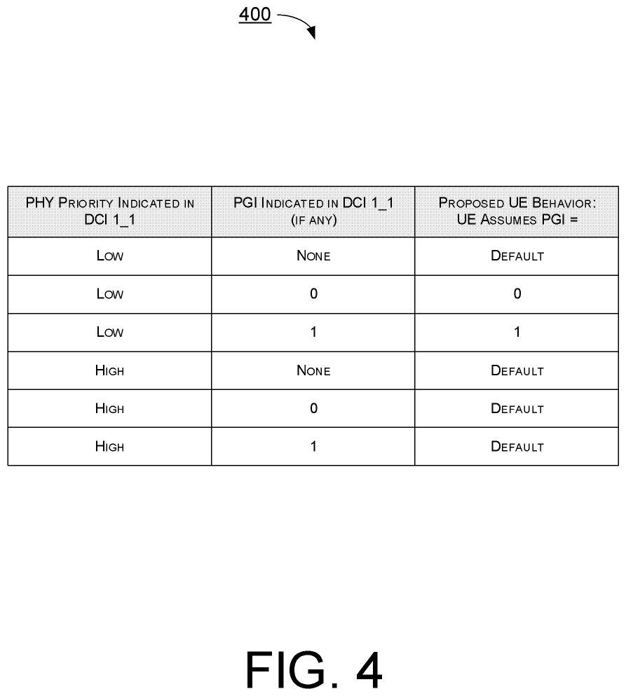

In a fourth case (Case 4) under the third proposed scheme, UE 110 may be configured to monitor both DCI formats 1_1 and 1_2 with PHY priority indication being configured only in DCI format 1_1. For a PDSCH scheduled by DCI format 1_2, the PGI for a HARQ feedback in a PUCCH occasion in slot/sub-slot X may follow the PGI indicated in DCI format 1_1 for the same PUCCH occasion in slot/sub-slot X in case the PHY priority indicated in DCI format 1_1 is low. In case UE 110 does not detect at least one DCI format 1_1 indicating PGI=0 or 1 with a PUCCH occasion in slot/sub-slot X, then UE 110 may assume a default PGI. In case the PHY priority in DCI format 1_1 is high, then UE 110 may assume a default PGI. For instance, the default PGI may be 0. Alternatively, the default PGI may be 1. Still alternatively, the default PGI may be configured by higher layers (e.g., as RRC parameters in RRC signaling). In some cases, in case the PHY priority in DCI format 1_1 is high, then UE 110 may utilize another available PGI. FIG. 4 illustrates an example scenario 400 of UE behavior for indicated PGI and PHY priority in DCI format 1_1.

Under the third proposed scheme, UE 110 may follow similar procedure(s) described above for NFI. Moreover, under the third proposed scheme, the request bit field RQ may be used to request the same PGI priority only.

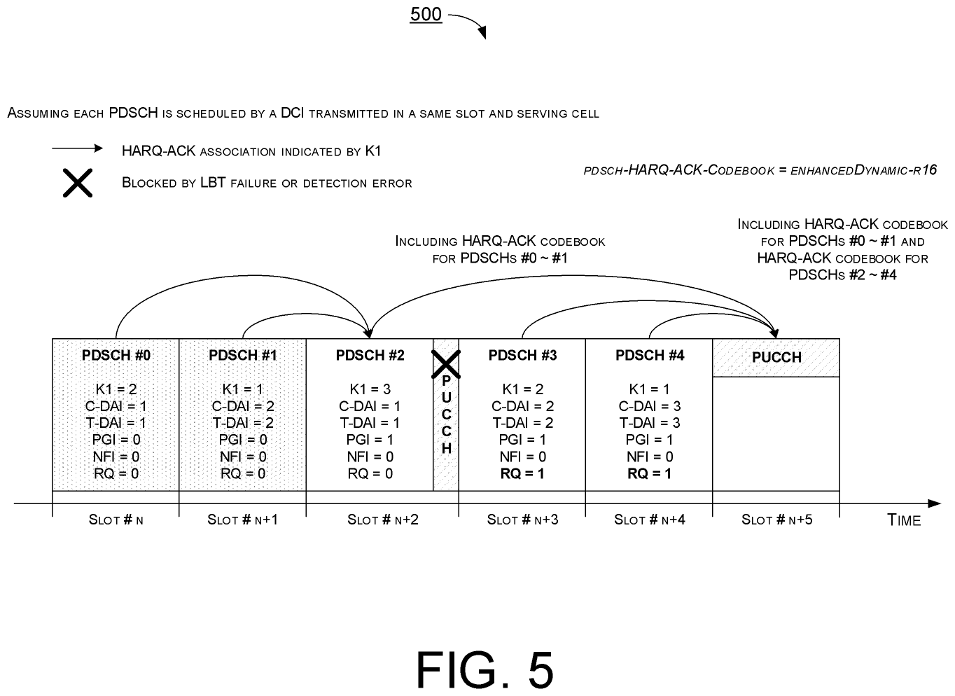

There may be other aspects of enhanced Type-2 codebook generation that need to be addressed. DCI format 1_1 may request feedback for one or two groups in a same PUCCH occasion. This may be indicated by a separate request (RQ) field in DCI format 1_1. For instance, RQ=0 may indicate to feedback the scheduled group, which is the PDSCH group having the same PGI in the requesting DCI. Moreover, RQ=1 may indicate to feedback both groups. When two groups exist in the same PUCCH occasion, the placement of HARQ-ACK codebooks for the two groups may be ordered based on increasing group index. FIG. 5 illustrates an example scenario 500 of UE behavior under the proposed scheme. In scenario 500, it is assumed that each PDSCH is scheduled by a DCI transmitted in a same slot and serving cell and that HARQ association is indicated by K1. Also, in scenario 500, the first PUCCH shown in FIG. 5 is blocked either by LBT failure or detection error. Thus, in the second PUCCH shown in FIG. 5, UE 110 may include HARQ-ACK codebook for PDSCHs #0-#1 as well as HARQ-ACK codebook for PDSCHs #2-#4.

With respect to codebook generation for a non-scheduled group (which refers to a group that corresponds to a previous COT and not a current COT), in case a DCI format 1_1 requests a HARQ-ACK feedback for two groups in the same PUCCH occasion, the codebook for the non-scheduled group may be generated according to additional NFI and total DAI (T-DAI) fields included in the DCI format 1_1 (e.g., when UE 110 is provided with NFI-TotalDAI-Included-r16=enable). With respect to multiplexing HARQ-ACK feedbacks in a PUSCH, in Release 15 (Rel-15) of the 3GPP specification, in case UE 110 is provided with pdsch-HARQ-ACK-Codebook=Dynamic-r16, then DCI format 0_1 may include T-DAI for generating a HARQ-ACK codebook that is multiplexed in the scheduled PUSCH. In Rel-16 NR-U, in case UE 110 is provided with pdsch-HARQ-ACK-Codebook=enhancedDynamic-r16, then the T-DAI present in DCI format 0_1 may be applied to one or two PDSCH groups.

In case UE 110 is provided with NFI-TotalDAI-Included-r16=enable to indicate that NFI and T-DAI fields for the non-scheduled group are included in the requesting DCI, then UE 110 may proceed differently depending on the detected NFI for the non-scheduled group. In an event that the detected NFI for the non-scheduled group (NFI-1) is the same as the NFI indicated for the non-scheduled group in the request DCI (NFI-2), then UE 110 may generate a HARQ-ACK codebook for the non-scheduled group according to the T-DAI indicated for the non-scheduled group in the requesting DCI (T-DAI-2). In an event that the detected NFI for the non-scheduled group (NFI-1) is not the same as the NFI indicated for the non-scheduled group in the request DCI (NFI-2), then UE 110 may generate all negative acknowledgements (NACKs) for the non-scheduled group according to the T-DAI indicated for the non-scheduled group in the requesting DCI (T-DAI-2).

In case UE 110 is not provided with NFI-TotalDAI-Included-r16=enable, then UE 110 may generate a HARQ-ACK codebook for the non-scheduled group according to the most recently detected counter DAI (C-DAI) and/or T-DAI indicated in the Das scheduling the non-scheduled group. However, there may be ambiguity between network node 125 and UE 110 in an event that a PUCCH occasion contains two HARQ-ACK codebooks.

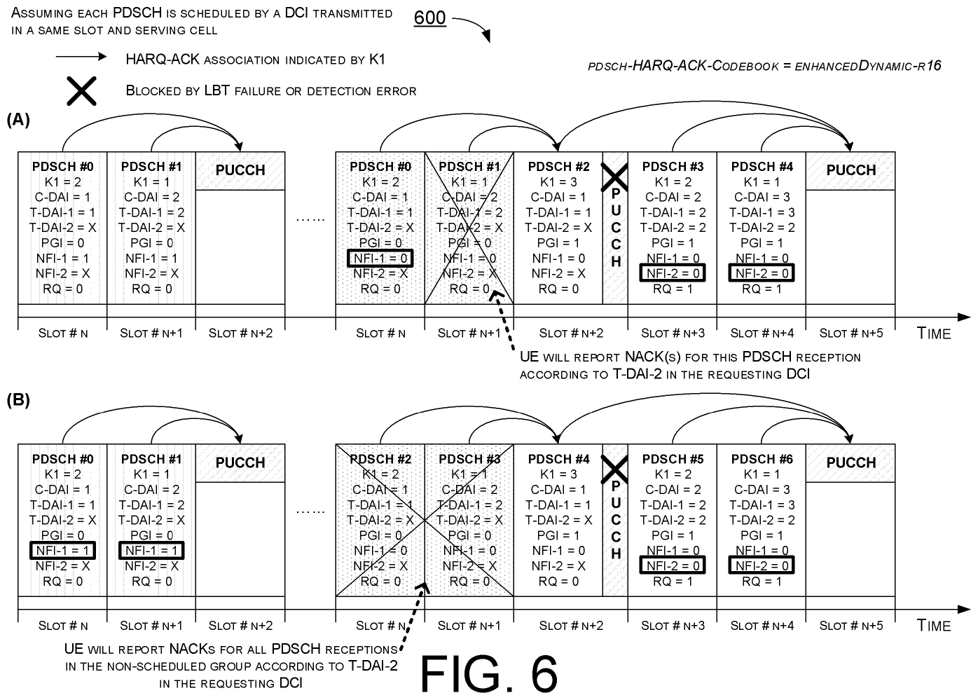

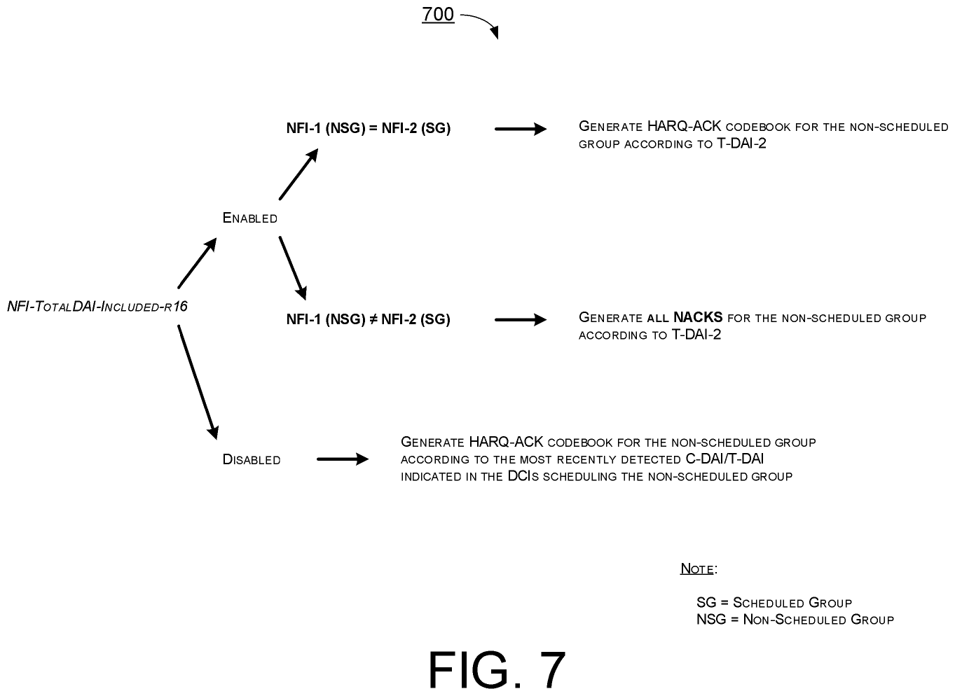

FIG. 6 illustrates an example scenario 600 of UE behavior under the proposed scheme. In scenario 600, it is assumed that each PDSCH is scheduled by a DCI transmitted in a same slot and serving cell and that HARQ association is indicated by K1. In part (A) of FIG. 6, as PDSCH #1 is missed for whatever reason (e.g., reception failure), UE 110 may report NACK(s) for PDSCH #1 reception according to T-DAI-2 in the requesting DCI. In part (B) of FIG. 6, as PDSCH #2 and PDSCH #3 are missed for whatever reason (e.g., reception failure), UE 110 may report all NACKs for all PDSCH receptions in the non-scheduled group according to T-DAI-2 in the requesting DCI. FIG. 7 illustrates an example scenario 700 of UE behavior under the proposed scheme. Specifically, scenario 700 shows UE behavior when NFI-TotalDAI-Included-r16 is enabled and when NFI-TotalDAI-Included-r16 is disabled.

Codebook generation for non-scheduled group may allow for codebook generating for two PDSCH groups in the same PUCCH. There are two methods that may be used to construct the codebook depending on whether NFI-TotalDAI-Included-r16 is enabled or not. When NFI-TotalDAI-Included-r16 is enabled, the last T-DAI and NFI for a PDSCH group 1 may be included in a DL grant scheduling PDSCH in PDSCH group 2. However, this may add to the DCI overhead and may compromise the reliability of the DCI. Also, concatenating two HARQ-ACK codebooks on the same PUCCH may compromise the reliability of the PUCCH.

Under a fourth proposed scheme in accordance with the present disclosure with respect to enhancement to codebook generation for a non-scheduled group, in order to avoid compromising the reliability of PUCCH, a HARQ-ACK for a scheduled group may be dropped in an event that the non-scheduled group corresponds to a high priority HARQ-ACK codebook while the scheduled group corresponds to a low priority HARQ-ACK codebook. In case concatenation is used with RQ, a new PG may inherit the priority of the previous PG in case it has a high priority. Conversely, in order to avoid compromising the reliability of PUCCH, a HARQ-ACK for a non-scheduled group may be dropped (e.g., RQ=0) in an event that the scheduled group corresponds to a high priority HARQ-ACK codebook while the non-scheduled group corresponds to a low priority HARQ-ACK codebook. Alternatively, UE 110 may be not expected to receive (or to allow) the RQ request (e.g., UE 110 may ignore RQ and may transmit only the current group). Moreover, in order to avoid compromising the reliability of PUCCH, UE 110 may be not expected to be configured with NFI-TotalDAI-Included-r16 RRC parameter for high-priority HARQ or the high-priority PDSCH groups (or PDSCH groups associated to high-priority HARQ-ACK codebooks or scheduled with DCI format 1_2 or with a specific radio network temporary identifier (RNTI) such as MCS-C-RNTI). For instance, to preserve the PDCCH reliability, such fields may not be configured for DCI format 1_2 or 1_1 in case the priority indication is configured. Moreover, NFI-TotalDAI-Included-r16 may be defined per DCI format. In such case, NFI-TotalDAI-Included-r16 may be used only for low-priority PDSCH groups or PDSCH groups associated to low-priority HARQ-ACK codebooks.

With respect to requesting for a one-shot HARQ-ACK feedback, UE 110 may be provided with pdsch-HARQ-ACK-OneShotFeedback-r16, and DCI format 1_1 may request a HARQ-ACK feedback containing all configured HARQ processes for all configured cells in the PUCCH occasion indicated by the DL DCI. In such cases, requesting or not may be indicated by a separate field in DCI format 1_1. DCI format 1_1 requesting one-shot HARQ-ACK codebook may either schedule or not schedule a PDSCH. One value of the frequency domain resource assignment field may indicate that this DCI does not schedule a PDSCH, an UE 110 may ignore the HARQ process identifier (ID) and NDI fields. Regarding configurability on top of type-1, Type-2 or enhanced Type-2 codebook, when more than one codebook types are requested in the same PUCCH occasion, only one-shot HARQ-ACK codebook may be reported in the PUCCH occasion.

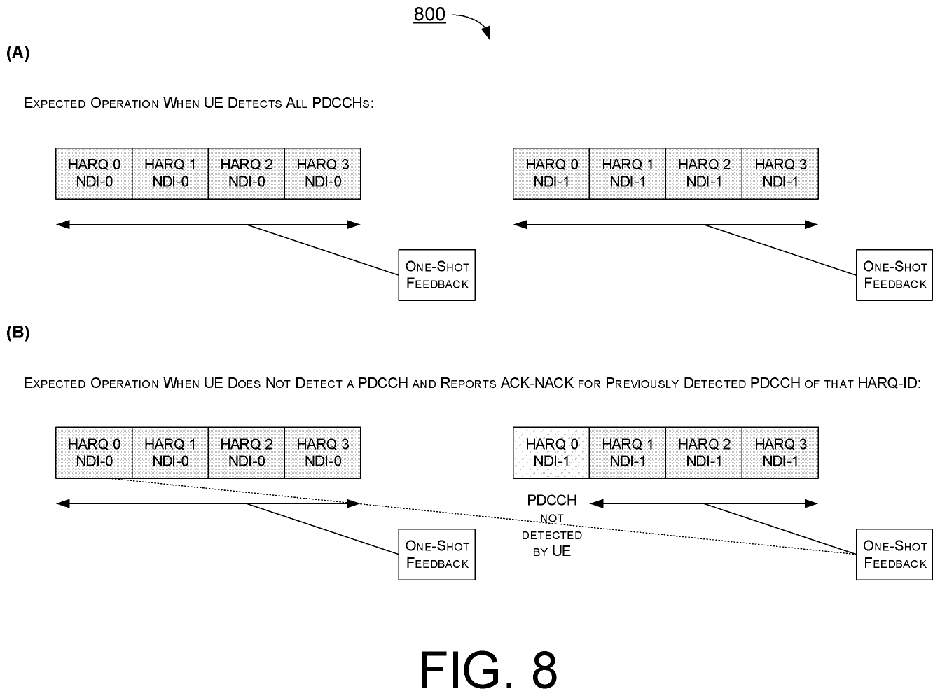

With respect to NDI reporting in one-shot HARQ-ACK codebooks, NDI may be configured to be part of a one-shot HARQ-ACK codebook. When pdsch-HARQ-ACK-OneShotFeedbackNDI-r16 is provided, the latest NDI detected by UE 110 may be reported along with HARQ-ACK for the corresponding HARQ process ID. UE 110 may assume NDI=0 in case there is no priori NDI for the HARQ process. When pdsch-HARQ-ACK-OneShotFeedbackNDI-r16 is not provided, NDI may be not reported along with HARQ-ACK for the corresponding PDSCH. UE 110 may be expected to reset HARQ-ACK state (as discontinuous transmission (DTX) or NACK) for a HARQ process ID once ACK is reported for the same HARQ process ID in the previous feedback. FIG. 8 illustrates an example scenario 800 under the proposed scheme. Part (A) of FIG. 8 shows expected UE behavior or operation when UE 110 detects all PDCCHs. Part (B) of FIG. 8 shows expected UE behavior or operation when UE 110 does not detect a PDCCH and reports ACK-NACK for previously detected PDCCH of that HARQ-ID. In the example shown in FIG. 8, when UE 110 does not detect the PDCCH associated with HARQ 0 (and NDI-1), then UE 110 may report ACK-NACK for the previously detected PDCCH associated with HARQ 0 (and NDI-0).

Under a fifth proposed scheme in accordance with the present disclosure with respect to enhancement to one-shot HARQ-ACK codebooks, a one-shot HARQ-ACK feedback may request a HARQ-ACK feedback containing all configured HARQ processes for all configured cells. This may be similar to a semi-static HARQ feedback method. The latest received NDI bits may be reported with the HARQ-ACK feedback for all HARQ processes. However, overhead may be increased by reporting the NDI as well, while overhead reduction is required for URLLC reliability. In Rel-16, only DCI format 1_1 may make this request. Under the fifth proposed scheme, DCI format 1_2 may be enabled to make the one-shot HARQ-ACK feedback request. In Rel-16, the request may be done for all configured HARQ processes for all configured cells. Yet, to allow for faster and reduced payload feedback, it may be possible to introduce some restrictions and/or selections. In one approach under the fifth proposed scheme, the request may be done only for PDSCHs associated with a high-priority HARQ-ACK feedback or DCI associated to a specific RNTI (e.g., C-RNTI, MCS-C-RNTI and so on), search space, or different DCI format/size (e.g., DCI format 2_1). In another approach under the fifth proposed scheme, the request may be done only for some cells (e.g., cells with DCI format 2_1 configured for monitoring or cells carrying high-priority HARQ-ACK codebooks). To achieve fast reporting, the request may be sent on the group common DCI format 2_0 (e.g., by adding once or multiple new fields in DCI format 2_0).

Under a sixth proposed scheme in accordance with the present disclosure with respect to compact DCI versus unlicensed spectrum, UE 110 may be not expected to be configured with DCI format 1_2 and/or DCI format 0_2 monitoring when enhanced Type-2 codebook (pdsch-HARQ-ACK-Codebook=enhancedDynamic-r16) is enabled. Under the sixth proposed scheme, UE 110 may be not expected to be configured with DCI Format 1_2/0_2 monitoring when one-shot HARQ-ACK codebook (pdsch-HARQ-ACK-OneShotFeedback-r16) is enabled. Additionally, UE 110 may not expect PDSCH scheduled by DCI format 1_2 to belong to any PDSCH group. Moreover, UE 110 may be not expected to be configured with DCI format 1_2/0_2 monitoring when codebook generation for non-scheduled group is enabled. Furthermore, UE 110 may be not expected to be configured with DCI format 1_2/0_2 monitoring when NFI-TotalDAI-Included r16 is enabled. Also, UE 110 may be not expected to have different priority HARQ-ACK codebooks generated for two PDSCH groups in the same PUCCH.

Under a seventh proposed scheme in accordance with the present disclosure with respect to compact DCI versus unlicensed spectrum, DCI format 1_2/0_2 monitoring on unlicensed spectrum may be supported as a UE capability. DCI format 1_2/0_2 monitoring when enhanced Type-2 codebook is enabled (pdsch-HARQ-ACK-Codebook=enhancedDynamic-r16) may be supported as a UE capability. DCI format 1_2/0_2 monitoring when one-shot HARQ-ACK codebook (pdsch-HARQ-ACK-OneShotFeedback-r16) may be supported as a UE capability. DCI format 1_2/0_2 monitoring when codebook generation for non-scheduled group is supported as a UE capability. DCI format 1_2/0_2 monitoring when NFI-TotalDAI-Included-r16=enabled may be supported as a UE capability. Generation of different priority HARQ-ACK codebooks for two PDSCH groups in the same PUCCH may be supported as a UE capability.

### Illustrative Implementations

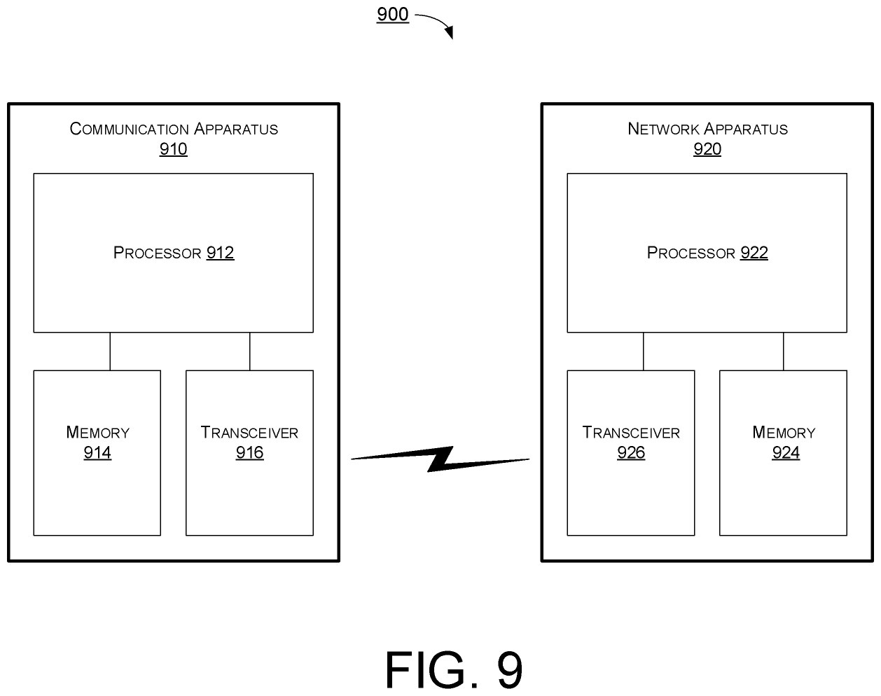

FIG. 9 illustrates an example communication apparatus 910 and an example network apparatus 920 in accordance with an implementation of the present disclosure. Each of communication apparatus 910 and network apparatus 920 may perform various functions to implement schemes, techniques, processes and methods described herein pertaining to URLLC enhancement on unlicensed spectrum in mobile communications, including scenarios/schemes described above as well as processes described below.

Communication apparatus 910 may be a part of an electronic apparatus, which may be a UE such as a portable or mobile apparatus, a wearable apparatus, a wireless communication apparatus or a computing apparatus. For instance, communication apparatus 910 may be implemented in a smartphone, a smartwatch, a personal digital assistant, a digital camera, or a computing equipment such as a tablet computer, a laptop computer or a notebook computer. Communication apparatus 910 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 910 may be implemented in a smart thermostat, a smart fridge, a smart door lock, a wireless speaker or a home control center. Alternatively, communication apparatus 910 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 910 may include at least some of those components shown in FIG. 9 such as a processor 912, for example. Communication apparatus 910 may further include one or more other components not pertinent to the proposed scheme of the present disclosure (e.g., internal power supply, display device and/or user interface device), and, thus, such component(s) of communication apparatus 910 are neither shown in FIG. 9 nor described below in the interest of simplicity and brevity.

Network apparatus 920 may be a part of an electronic apparatus/station, which may be a network node such as a base station, a small cell, a router, a gateway or a satellite. For instance, network apparatus 920 may be implemented in an eNodeB in an LTE, in a gNB in a 5G, NR, IoT, NB-IoT, IIoT, or in a satellite in an NTN network. Alternatively, network apparatus 920 may be implemented in the form of one or more IC chips such as, for example and without limitation, one or more single-core processors, one or more multi-core processors, or one or more RISC or CISC processors. Network apparatus 920 may include at least some of those components shown in FIG. 9 such as a processor 922, for example. Network apparatus 920 may further include one or more other components not pertinent to the proposed scheme of the present disclosure (e.g., internal power supply, display device and/or user interface device), and, thus, such component(s) of network apparatus 920 are neither shown in FIG. 9 nor described below in the interest of simplicity and brevity.

In one aspect, each of processor 912 and processor 922 may be implemented in the form of one or more single-core processors, one or more multi-core processors, or one or more CISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including power consumption reduction in a device (e.g., as represented by communication apparatus 910) and a network (e.g., as represented by network apparatus 920) in accordance with various implementations of the present disclosure.

In some implementations, communication apparatus 910 may also include a transceiver 916 coupled to processor 912 and capable of wirelessly transmitting and receiving data. In some implementations, communication apparatus 910 may further include a memory 914 coupled to processor 912 and capable of being accessed by processor 912 and storing data therein. In some implementations, network apparatus 920 may also include a transceiver 926 coupled to processor 922 and capable of wirelessly transmitting and receiving data. In some implementations, network apparatus 920 may further include a memory 924 coupled to processor 922 and capable of being accessed by processor 922 and storing data therein. Accordingly, communication apparatus 910 and network apparatus 920 may wirelessly communicate with each other via transceiver 916 and transceiver 926, respectively.

Each of communication apparatus 910 and network apparatus 920 may be a communication entity capable of communicating with each other using various proposed schemes in accordance with the present disclosure. To aid better understanding, the following description of the operations, functionalities and capabilities of each of communication apparatus 910 and network apparatus 920 is provided in the context of a mobile communication environment in which communication apparatus 910 is implemented in or as a communication apparatus or a UE (e.g., UE 110) and network apparatus 920 is implemented in or as a network node or base station (e.g., network node 125) of a communication network (e.g., wireless network 120). It is also noteworthy that, although the example implementations described below are provided in the context of mobile communications, the same may be implemented in other types of networks.

Under a proposed scheme pertaining to URLLC enhancement on unlicensed spectrum in mobile communications in accordance with the present disclosure, with communication apparatus 910 implemented in or as UE 110 and network apparatus 920 implemented in or as network node 125 in network environment 100, processor 912 of communication apparatus 910 may determine grouping of a plurality of PDSCH receptions scheduled by DCI formats 1_1 and 1_2 in a same PDSCH group from a network node (e.g., network apparatus 920 as network node 125 in network 120) on a NR-U. Additionally, processor 912 may perform, via transceiver 916, the PDSCH receptions from network apparatus 920 based on the determined grouping.

In some implementations, the DCI format 1_2 may contain a PGI field and an NFI field.

In some implementations, DCI formats 1_0, 1_1 and 1_2 may be in the same PDSCH group.

In some implementations, processor 912 may perform additional operations. For instance, processor 912 may monitor, via transceiver 916, both the DCI formats 1_1 and 1_2 with no PHY priority indication configured. Alternatively, processor 912 may monitor, via transceiver 916, both the DCI formats 1_1 and 1_2 with the PHY priority indication configured in both the DCI formats 1_1 and 1_2. Alternatively, processor 912 may monitor, via transceiver 916, both the DCI formats 1_1 and 1_2 with the PHY priority indication configured in the DCI format 1_2 but not in the DCI format 1_1. Alternatively, processor 912 may monitor, via transceiver 916, both the DCI formats 1_1 and 1_2 with the PHY priority indication configured in the DCI format 1_1 but not in the DCI format 1_2.

Under a proposed scheme pertaining to URLLC enhancement on unlicensed spectrum in mobile communications in accordance with the present disclosure, with communication apparatus 910 implemented in or as UE 110 and network apparatus 920 implemented in or as network node 125 in network environment 100, processor 912 of communication apparatus 910 may communicate, via transceiver 916, with a network node (e.g., network apparatus 920 as network node 125 in network 120) on a NR-U and using a HARQ procedure. Moreover, processor 912 may generate a first HARQ-ACK codebook corresponding to a non-scheduled group and a second HARQ-ACK codebook corresponding to a scheduled group. Furthermore, processor 912 may transmit, via transceiver 916, to apparatus 920 either the first HARQ-ACK codebook or the second HARQ-ACK codebook in a PUCCH occasion based on a respective priority of each of the first HARQ-ACK codebook and the second HARQ-ACK codebook.

In some implementations, in transmitting either the first HARQ-ACK codebook or the second HARQ-ACK codebook in the PUCCH occasion, processor 912 may perform certain operations responsive to the first HARQ-ACK codebook having a higher priority than that of the second HARQ-ACK codebook. For instance, processor 912 may transmit the first HARQ-ACK codebook corresponding to the non-scheduled group in the PUCCH occasion. Additionally, processor 912 may drop the second HARQ-ACK codebook corresponding to the scheduled group. Alternatively, in transmitting either the first HARQ-ACK codebook or the second HARQ-ACK codebook in the PUCCH occasion, processor 912 may perform certain operations responsive to the second HARQ-ACK codebook having a higher priority than that of the first HARQ-ACK codebook. For instance, processor 912 may transmit the second HARQ-ACK codebook corresponding to the scheduled group in the PUCCH occasion. Moreover, processor 912 may drop the first HARQ-ACK codebook corresponding to the non-scheduled group.

In some implementations, processor 912 may perform additional operations. For instance, processor 912 may receive, via transceiver 916, from apparatus 920 a one-shot HARQ-ACK feedback request in a DCI format 1_2. Furthermore, processor 912 may transmit, via transceiver 916 and in the PUCCH occasion or in another PUCCH occasion, a HARQ-ACK feedback containing all configured HARQ processes associated with one or more requested cells.

In some implementations, the one-shot HARQ-ACK feedback request may pertain to PDSCHs associated with a high-priority HARQ-ACK feedback or DCI associated with a specific RNTI, a specific search space, or DCI format 2_1.

In some implementations, the one or more requested cells may include one or more cells with DCI format 2_1 monitoring configured or one or more cells carrying a high-priority HARQ-ACK codebook.

In some implementations, in receiving the one-shot HARQ-ACK feedback request, processor 912 may receive the one-shot HARQ-ACK feedback request on a group common DCI format 2_0.

In some implementations, monitoring of DCI format 1_2 and DCI format 0_2 may not be performed when an enhanced Type-2 codebook is enabled.

In some implementations, processor 912 may perform additional operations. For instance, processor 912 may monitor, via transceiver 916, both DCI formats 1_2 and DCI format 0_2 on the NR-U. Alternatively, processor 912 may monitor, via transceiver 916, both the DCI formats 1_2 and the DCI format 0_2 when an enhanced Type-2 codebook is enabled. Alternatively, processor 912 may monitor, via transceiver 916, both the DCI formats 1_2 and the DCI format 0_2 when one-shot HARQ-ACK codebook is supported. Alternatively, processor 912 may monitor, via transceiver 916, both the DCI formats 1_2 and the DCI format 0_2 when codebook generation for a non-scheduled group is supported. Alternatively, processor 912 may monitor, via transceiver 916, both the DCI formats 1_2 and the DCI format 0_2 when a codebook for a non-scheduled group is generated according to an NFI field and a T-DAI field. Alternatively, processor 912 may generate HARQ-ACK codebooks of different priorities for two PDSCH groups in a same PUCCH.

Under a proposed scheme pertaining to URLLC enhancement on unlicensed spectrum in mobile communications in accordance with the present disclosure, with communication apparatus 910 implemented in or as UE 110 and network apparatus 920 implemented in or as network node 125 in network environment 100, processor 912 of communication apparatus 910 may receive, via transceiver 916, from a network node (e.g., network apparatus 920 as network node 125 in network 120) a one-shot HARQ-ACK feedback request in a DCI format 1_2. Moreover, processor 912 may transmit, via transceiver 916 and in a PUCCH occasion, a HARQ-ACK feedback containing all configured HARQ processes associated with one or more requested cells.

In some implementations, the one-shot HARQ-ACK feedback request may pertain to PDSCHs associated with a high-priority HARQ-ACK feedback or DCI associated with a specific RNTI, a specific search space, or DCI format 2_1.

In some implementations, the one or more requested cells may include one or more cells with DCI format 2_1 monitoring configured or one or more cells carrying a high-priority HARQ-ACK codebook.

In some implementations, in receiving the one-shot HARQ-ACK feedback request, processor 912 may receive the one-shot HARQ-ACK feedback request on a group common DCI format 2_0.

Under a proposed scheme pertaining to URLLC enhancement on unlicensed spectrum in mobile communications in accordance with the present disclosure, with communication apparatus 910 implemented in or as UE 110 and network apparatus 920 implemented in or as network node 125 in network environment 100, processor 912 of communication apparatus 910 may communicate, via transceiver 916, with a network node (e.g., network apparatus 920 as network node 125 in network 120) on a NR-U and using a HARQ procedure. Additionally, processor 912 may transmit, via transceiver 916, a PUCCH to apparatus 920 in an event that the PUCCH is missed during an original COT.

In some implementations, in transmitting the PUCCH, processor 912 may perform certain operations. For instance, processor 912 may transmit the PUCCH using LBT category 4 to access and transmit the PUCCH on a channel. Alternatively, processor 912 may transmit the PUCCH using LBT category 4 to access the channel and transmit the PUCCH on a CG PUSCH resource. Alternatively, processor 912 may transmit the PUCCH on a PUCCH resource signaled by the network node in DCI format 2_0 at a start of a subsequent COT. Alternatively, processor 912 may transmit the PUCCH on a fixed PUCCH resource at the start of the subsequent COT.

Under a proposed scheme pertaining to URLLC enhancement on unlicensed spectrum in mobile communications in accordance with the present disclosure, with communication apparatus 910 implemented in or as UE 110 and network apparatus 920 implemented in or as network node 125 in network environment 100, processor 912 of communication apparatus 910 may communicate, via transceiver 916, with a network node (e.g., network apparatus 920 as network node 125 in network 120) on a NR-U and using a HARQ procedure. Furthermore, processor 912 may receive, via transceiver 916, from apparatus 920 a plurality of PDSCH groups. Each PDSCH group of the plurality of PDSCH groups may be associated with a respective HARQ-ACK codebook. Each priority level of a plurality of priority levels may correspond to respective two PDSCH groups of the plurality of PDSCH groups.

In some implementations, a number of PDSCH groups in the plurality of PDSCH groups may be configured by RRC signaling or specified per HARQ-ACK codebook priority.

In some implementations, a respective priority of each PDSCH group of the plurality of PDSCH groups may be determined based on: (a) a priority of an associated HARQ codebook; or (b) a priority of a DCI signaling that schedules the respective PDSCH group; or (c) an assigned priority for the respective PDSCH group; or (d) a separately configured priority for the respective PDSCH group.

### Illustrative Processes

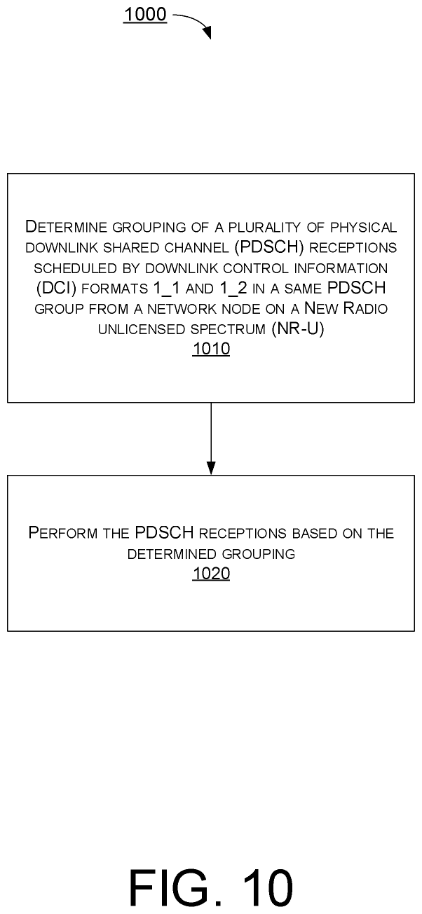

FIG. 10 illustrates an example process 1000 in accordance with an implementation of the present disclosure. Process 1000 may be an example implementation of schemes described above, whether partially or completely, with respect to URLLC enhancement on unlicensed spectrum in mobile communications in accordance with the present disclosure. Process 1000 may represent an aspect of implementation of features of communication apparatus 910. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks of process 1000 may executed in the order shown in FIG. 10 or, alternatively, in a different order. Process 1000 may be implemented by communication apparatus 910 or any suitable UE or machine type devices. Solely for illustrative purposes and without limitation, process 1000 is described below in the context of communication apparatus 910 and network apparatus 920. Process 1000 may begin at block 1010.

At 1010, process 1000 may involve processor 912 of communication apparatus 910, implemented in or as UE 110, determining grouping of a plurality of PDSCH receptions scheduled by DCI formats 1_1 and 1_2 in a same PDSCH group from a network node (e.g., network apparatus 920 as network node 125 in network 120) on a NR-U. Process 1000 may proceed from 1010 to 1020.

At 1020, process 1000 may involve processor 912 performing, via transceiver 916, the PDSCH receptions from network apparatus 920 based on the determined grouping.

In some implementations, the DCI format 1_2 may contain a PGI field and an NFI field.

In some implementations, DCI formats 1_0, 1_1 and 1_2 may be in the same PDSCH group.

In some implementations, process 1000 may involve processor 912 performing additional operations. For instance, process 1000 may involve processor 912 monitoring, via transceiver 916, both the DCI formats 1_1 and 1_2 with no PHY priority indication configured. Alternatively, process 1000 may involve processor 912 monitoring, via transceiver 916, both the DCI formats 1_1 and 1_2 with the PHY priority indication configured in both the DCI formats 1_1 and 1_2. Alternatively, process 1000 may involve processor 912 monitoring, via transceiver 916, both the DCI formats 1_1 and 1_2 with the PHY priority indication configured in the DCI format 1_2 but not in the DCI format 1_1. Alternatively, process 1000 may involve processor 912 monitoring, via transceiver 916, both the DCI formats 1_1 and 1_2 with the PHY priority indication configured in the DCI format 1_1 but not in the DCI format 1_2.

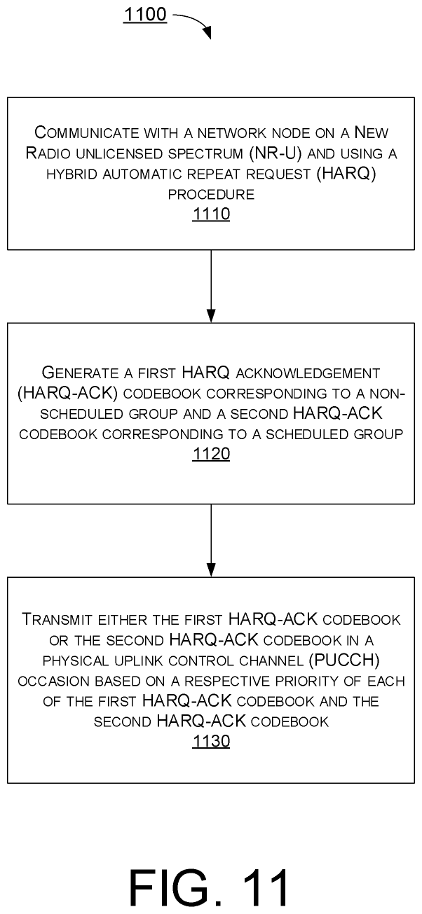

FIG. 11 illustrates an example process 1100 in accordance with an implementation of the present disclosure. Process 1100 may be an example implementation of schemes described above, whether partially or completely, with respect to URLLC enhancement on unlicensed spectrum in mobile communications in accordance with the present disclosure. Process 1100 may represent an aspect of implementation of features of communication apparatus 910. Process 1100 may include one or more operations, actions, or functions as illustrated by one or more of blocks 1110, 1120 and 1130. Although illustrated as discrete blocks, various blocks of process 1100 may be divided into additional blocks, combined into fewer blocks, or eliminated, depending on the desired implementation. Moreover, the blocks of process 1100 may executed in the order shown in FIG. 11 or, alternatively, in a different order. Process 1100 may be implemented by communication apparatus 910 or any suitable UE or machine type devices. Solely for illustrative purposes and without limitation, process 1100 is described below in the context of communication apparatus 910 and network apparatus 920. Process 1100 may begin at block 1110.

At 1110, process 1100 may involve processor 912 of communication apparatus 910, implemented in or as UE 110, communicating, via transceiver 916, with a network node (e.g., network apparatus 920 as network node 125 in network 120) on a NR-U and using a HARQ procedure. Process 1100 may proceed from 1110 to 1120.

At 1120, process 1100 may involve processor 912 generating a first HARQ-ACK codebook corresponding to a non-scheduled group and a second HARQ-ACK codebook corresponding to a scheduled group. Process 1100 may proceed from 1120 to 1130.

At 1130, process 1100 may involve processor 912 transmitting, via transceiver 916, to apparatus 920 either the first HARQ-ACK codebook or the second HARQ-ACK codebook in a PUCCH occasion based on a respective priority of each of the first HARQ-ACK codebook and the second HARQ-ACK codebook.

In some implementations, in transmitting either the first HARQ-ACK codebook or the second HARQ-ACK codebook in the PUCCH occasion, process 1100 may involve processor 912 performing certain operations responsive to the first HARQ-ACK codebook having a higher priority than that of the second HARQ-ACK codebook. For instance, process 1100 may involve processor 912 transmitting the first HARQ-ACK codebook corresponding to the non-scheduled group in the PUCCH occasion. Additionally, process 1100 may involve processor 912 dropping the second HARQ-ACK codebook corresponding to the scheduled group. Alternatively, in transmitting either the first HARQ-ACK codebook or the second HARQ-ACK codebook in the PUCCH occasion, process 1100 may involve processor 912 performing certain operations responsive to the second HARQ-ACK codebook having a higher priority than that of the first HARQ-ACK codebook. For instance, process 1100 may involve processor 912 transmitting the second HARQ-ACK codebook corresponding to the scheduled group in the PUCCH occasion. Moreover, process 1100 may involve processor 912 dropping the first HARQ-ACK codebook corresponding to the non-scheduled group.

In some implementations, process 1100 may involve processor 912 performing additional operations. For instance, process 1100 may involve processor 912 receiving, via transceiver 916, from apparatus 920 a one-shot HARQ-ACK feedback request in a DCI format 1_2. Furthermore, process 1100 may involve processor 912 transmitting, via transceiver 916 and in the PUCCH occasion or in another PUCCH occasion, a HARQ-ACK feedback containing all configured HARQ processes associated with one or more requested cells.

In some implementations, the one-shot HARQ-ACK feedback request may pertain to PDSCHs associated with a high-priority HARQ-ACK feedback or DCI associated with a specific RNTI, a specific search space, or DCI format 2_1.

In some implementations, the one or more requested cells may include one or more cells with DCI format 2_1 monitoring configured or one or more cells carrying a high-priority HARQ-ACK codebook.

In some implementations, in receiving the one-shot HARQ-ACK feedback request, process 1100 may involve processor 912 receiving the one-shot HARQ-ACK feedback request on a group common DCI format 2_0.

In some implementations, monitoring of DCI format 1_2 and DCI format 0_2 may not be performed when an enhanced Type-2 codebook is enabled.

In some implementations, process 1100 may involve processor 912 performing additional operations. For instance, process 1100 may involve processor 912 monitoring, via transceiver 916, both DCI formats 1_2 and DCI format 0_2 on the NR-U. Alternatively, process 1100 may involve processor 912 monitoring, via transceiver 916, both the DCI formats 1_2 and the DCI format 0_2 when an enhanced Type-2 codebook is enabled. Alternatively, process 1100 may involve processor 912 monitoring, via transceiver 916, both the DCI formats 1_2 and the DCI format 0_2 when one-shot HARQ-ACK codebook is supported. Alternatively, process 1100 may involve processor 912 monitoring, via transceiver 916, both the DCI formats 1_2 and the DCI format 0_2 when codebook generation for a non-scheduled group is supported. Alternatively, process 1100 may involve processor 912 monitoring, via transceiver 916, both the DCI formats 1_2 and the DCI format 0_2 when a codebook for a non-scheduled group is generated according to an NFI field and a T-DAI field. Alternatively, process 1100 may involve processor 912 generating HARQ-ACK codebooks of different priorities for two PDSCH groups in a same PUCCH.

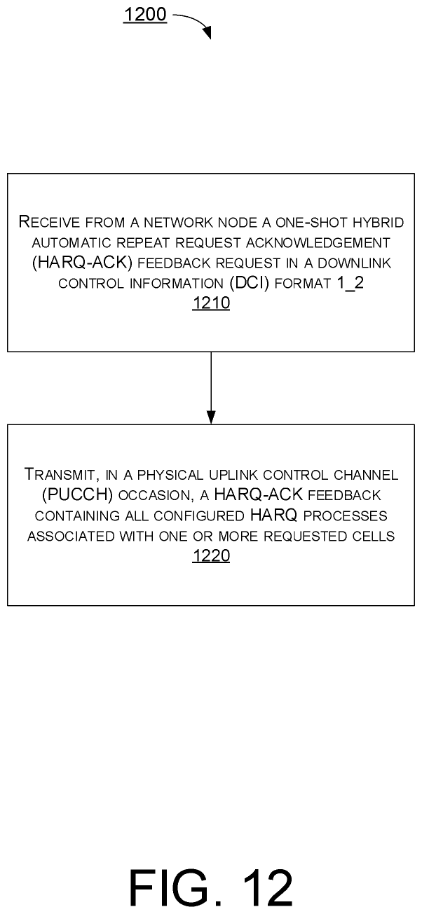

FIG. 12 illustrates an example process 1200 in accordance with an implementation of the present disclosure. Process 1200 may be an example implementation of schemes described above, whether partially or completely, with respect to URLLC enhancement on unlicensed spectrum in mobile communications in accordance with the present disclosure. Process 1200 may represent an aspect of implementation of features of communication apparatus 910. Process 1200 may include one or more operations, actions, or functions as illustrated by one or more of blocks 1210 and 1220. Although illustrated as discrete blocks, various blocks of process 1200 may be divided into additional blocks, combined into fewer blocks, or eliminated, depending on the desired implementation. Moreover, the blocks of process 1200 may executed in the order shown in FIG. 12 or, alternatively, in a different order. Process 1200 may be implemented by communication apparatus 910 or any suitable UE or machine type devices. Solely for illustrative purposes and without limitation, process 1200 is described below in the context of communication apparatus 910 and network apparatus 920. Process 1200 may begin at block 1210.

At 1210, process 1200 may involve processor 912 of communication apparatus 910, implemented in or as UE 110, receiving, via transceiver 916, from a network node (e.g., network apparatus 920 as network node 125 in network 120) a one-shot HARQ-ACK feedback request in a DCI format 1_2. Process 1200 may proceed from 1210 to 1220.

At 1220, process 1200 may involve processor 912 transmitting, via transceiver 916 and in a PUCCH occasion, a HARQ-ACK feedback containing all configured HARQ processes associated with one or more requested cells.

In some implementations, the one-shot HARQ-ACK feedback request may pertain to PDSCHs associated with a high-priority HARQ-ACK feedback or DCI associated with a specific RNTI, a specific search space, or DCI format 2_1.

In some implementations, the one or more requested cells may include one or more cells with DCI format 2_1 monitoring configured or one or more cells carrying a high-priority HARQ-ACK codebook.

In some implementations, in receiving the one-shot HARQ-ACK feedback request, process 1200 may involve processor 912 receiving the one-shot HARQ-ACK feedback request on a group common DCI format 2_0.

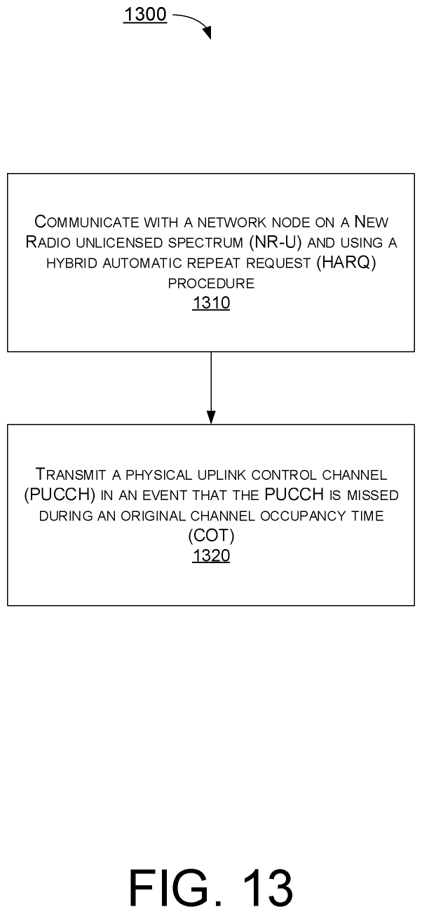

FIG. 13 illustrates an example process 1300 in accordance with an implementation of the present disclosure. Process 1300 may be an example implementation of schemes described above, whether partially or completely, with respect to URLLC enhancement on unlicensed spectrum in mobile communications in accordance with the present disclosure. Process 1300 may represent an aspect of implementation of features of communication apparatus 910. Process 1300 may include one or more operations, actions, or functions as illustrated by one or more of blocks 1310 and 1320. Although illustrated as discrete blocks, various blocks of process 1300 may be divided into additional blocks, combined into fewer blocks, or eliminated, depending on the desired implementation. Moreover, the blocks of process 1300 may executed in the order shown in FIG. 13 or, alternatively, in a different order. Process 1300 may be implemented by communication apparatus 910 or any suitable UE or machine type devices. Solely for illustrative purposes and without limitation, process 1300 is described below in the context of communication apparatus 910 and network apparatus 920. Process 1300 may begin at block 1310.

At 1310, process 1300 may involve processor 912 of communication apparatus 910, implemented in or as UE 110, communicating, via transceiver 916, with a network node (e.g., network apparatus 920 as network node 125 in network 120) on a NR-U and using a HARQ procedure. Process 1300 may proceed from 1310 to 1320.

At 1320, process 1300 may involve processor 912 transmitting, via transceiver 916, a PUCCH to apparatus 920 in an event that the PUCCH is missed during an original COT.

In some implementations, in transmitting the PUCCH, process 1300 may involve processor 912 performing certain operations. For instance, process 1300 may involve processor 912 transmitting the PUCCH using LBT category 4 to access and transmit the PUCCH on a channel. Alternatively, process 1300 may involve processor 912 transmitting the PUCCH using LBT category 4 to access the channel and transmit the PUCCH on a CG PUSCH resource. Alternatively, process 1300 may involve processor 912 transmitting the PUCCH on a PUCCH resource signaled by the network node in DCI format 2_0 at a start of a subsequent COT. Alternatively, process 1300 may involve processor 912 transmitting the PUCCH on a fixed PUCCH resource at the start of the subsequent COT.

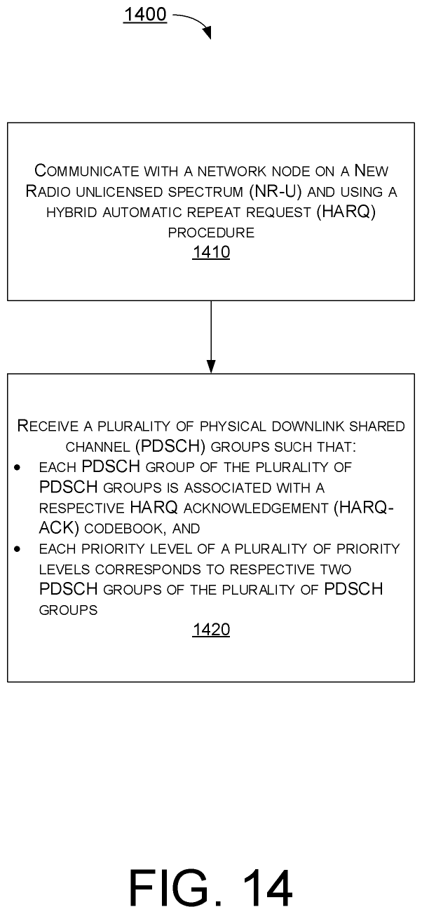

FIG. 14 illustrates an example process 1400 in accordance with an implementation of the present disclosure. Process 1400 may be an example implementation of schemes described above, whether partially or completely, with respect to URLLC enhancement on unlicensed spectrum in mobile communications in accordance with the present disclosure. Process 1400 may represent an aspect of implementation of features of communication apparatus 910. Process 1400 may include one or more operations, actions, or functions as illustrated by one or more of blocks 1410 and 1420. Although illustrated as discrete blocks, various blocks of process 1400 may be divided into additional blocks, combined into fewer blocks, or eliminated, depending on the desired implementation. Moreover, the blocks of process 1400 may executed in the order shown in FIG. 14 or, alternatively, in a different order. Process 1400 may be implemented by communication apparatus 910 or any suitable UE or machine type devices. Solely for illustrative purposes and without limitation, process 1400 is described below in the context of communication apparatus 910 and network apparatus 920. Process 1400 may begin at block 1410.

At 1410, process 1400 may involve processor 912 of communication apparatus 910, implemented in or as UE 110, communicating, via transceiver 916, with a network node (e.g., network apparatus 920 as network node 125 in network 120) on a NR-U and using a HARQ procedure. Process 1400 may proceed from 1410 to 1420.

At 1420, process 1400 may involve processor 912 receiving, via transceiver 916, from apparatus 920 a plurality of PDSCH groups. Each PDSCH group of the plurality of PDSCH groups may be associated with a respective HARQ-ACK codebook. Each priority level of a plurality of priority levels may correspond to respective two PDSCH groups of the plurality of PDSCH groups.

In some implementations, a number of PDSCH groups in the plurality of PDSCH groups may be configured by RRC signaling or specified per HARQ-ACK codebook priority.

In some implementations, a respective priority of each PDSCH group of the plurality of PDSCH groups may be determined based on: (a) a priority of an associated HARQ codebook; or (b) a priority of a DCI signaling that schedules the respective PDSCH group; or (c) an assigned priority for the respective PDSCH group; or (d) a separately configured priority for the respective PDSCH group.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
determining grouping of a plurality of physical downlink shared channel (PDSCH) receptions scheduled by downlink control information (DCI) formats 1_1 and 1_2 in a same PDSCH group from a network node on a New Radio unlicensed spectrum (NR-U); and
performing the PDSCH receptions based on the determined grouping.

2. The method of claim 1, wherein the DCI format 1_2 contains a PDSCH Group Index (PGI) field and a New Feedback Indicator (NFI) field.

3. The method of claim 1, wherein DCI formats 1_0, 1_1 and 1_2 are in the same PDSCH group.

4. The method of claim 1, further comprising:
monitoring both the DCI formats 1_1 and 1_2 with no physical layer (PHY) priority indication configured; or
monitoring both the DCI formats 1_1 and 1_2 with the PHY priority indication configured in both the DCI formats 1_1 and 1_2; or
monitoring both the DCI formats 1_1 and 1_2 with the PHY priority indication configured in the DCI format 1_2 but not in the DCI format 1_1; or
monitoring both the DCI formats 1_1 and 1_2 with the PHY priority indication configured in the DCI format 1_1 but not in the DCI format 1_2.

5. A method, comprising:
communicating with a network node on a New Radio unlicensed spectrum (NR-U) and using a hybrid automatic repeat request (HARQ) procedure;
generating a first HARQ acknowledgement (HARQ-ACK) codebook corresponding to a non-scheduled group and a second HARQ-ACK codebook corresponding to a scheduled group; and
transmitting either the first HARQ-ACK codebook or the second HARQ-ACK codebook in a physical uplink control channel (PUCCH) occasion based on a respective priority of each of the first HARQ-ACK codebook and the second HARQ-ACK codebook.

5. he method of claim 5, wherein the transmitting of either the first HARQ-ACK codebook or the second HARQ-ACK codebook in the PUCCH occasion comprises, responsive to the first HARQ-ACK codebook having a higher priority than that of the second HARQ-ACK codebook:
transmitting the first HARQ-ACK codebook corresponding to the non-scheduled group in the PUCCH occasion; and
dropping the second HARQ-ACK codebook corresponding to the scheduled group.

7. The method of claim 5, wherein the transmitting of either the first HARQ-ACK codebook or the second HARQ-ACK codebook in the PUCCH occasion comprises, responsive to the second HARQ-ACK codebook having a higher priority than that of the first HARQ-ACK codebook:
transmitting the second HARQ-ACK codebook corresponding to the scheduled group in the PUCCH occasion; and
dropping the first HARQ-ACK codebook corresponding to the non-scheduled group.

5. he method of claim 5, further comprising:
receiving from the network node a one-shot HARQ-ACK feedback request in a downlink control information (DCI) format 1_2; and
transmitting, in the PUCCH occasion or in another PUCCH occasion, a HARQ-ACK feedback containing all configured HARQ processes associated with one or more requested cells.

8. The method of claim 8, wherein the one-shot HARQ-ACK feedback request pertains to physical downlink shared channels (PDSCHs) associated with a high-priority HARQ-ACK feedback or downlink control information (DCI) associated with a specific radio network temporary identifier (RNTI), a specific search space, or DCI format 2_1.

10. The method of claim 8, wherein the one or more requested cells comprise one or more cells with DCI format 2_1 monitoring configured or one or more cells carrying a high-priority HARQ-ACK codebook.

11. The method of claim 8, wherein the receiving of the one-shot HARQ-ACK feedback request comprises receiving the one-shot HARQ-ACK feedback request on a group common DCI format 2_0.

10. he method of claim 10, wherein monitoring of DCI format 1_2 and DCI format 0_2 is not performed when an enhanced Type-2 codebook is enabled.

13. The method of claim 10, further comprising:
monitoring both DCI formats 1_2 and DCI format 0_2 on the NR-U; or
monitoring both the DCI formats 1_2 and the DCI format 0_2 when an enhanced Type-2 codebook is enabled; or
monitoring both the DCI formats 1_2 and the DCI format 0_2 when one-shot hybrid automatic repeat request acknowledgement (HARQ-ACK) codebook is supported; or
monitoring both the DCI formats 1_2 and the DCI format 0_2 when codebook generation for a non-scheduled group is supported; or
monitoring both the DCI formats 1_2 and the DCI format 0_2 when a codebook for a non-scheduled group is generated according to an New Feedback Indicator (NFI) field and a Total Downlink Assignment Index (T-DAI) field; or
generating HARQ-ACK codebooks of different priorities for two PDSCH groups in a same physical uplink control channel (PUCCH).

14. A method, comprising:
receiving from a network node a one-shot hybrid automatic repeat request acknowledgement (HARQ-ACK) feedback request in a downlink control information (DCI) format 1_2; and
transmitting, in a physical uplink control channel (PUCCH) occasion, a HARQ-ACK feedback containing all configured HARQ processes associated with one or more requested cells.

15. The method of claim 14, wherein the one or more requested cells comprise one or more cells with DCI format 2_1 monitoring configured or one or more cells carrying a high-priority HARQ-ACK codebook.

16. A method, comprising:
communicating with a network node on a New Radio unlicensed spectrum (NR-U) and using a hybrid automatic repeat request (HARQ) procedure; and
transmitting a physical uplink control channel (PUCCH) in an event that the PUCCH is missed during an original channel occupancy time (COT).

16. he method of claim 16, wherein the transmitting of the PUCCH comprises:
transmitting the PUCCH using listen-before-talk (LBT) category 4 to access and transmit the PUCCH on a channel; or
transmitting the PUCCH using LBT category 4 to access the channel and transmit the PUCCH on a configured-grant (CG) physical uplink shared channel (PUSCH) resource; or
transmitting the PUCCH on a PUCCH resource signaled by the network node in downlink control information (DCI) format 2_0 at a start of a subsequent COT; or transmitting the PUCCH on a fixed PUCCH resource at the start of the subsequent COT.

18. A method, comprising:
communicating with a network node on a New Radio unlicensed spectrum (NR-U) and using a hybrid automatic repeat request (HARQ) procedure; and
receiving a plurality of physical downlink shared channel (PDSCH) groups,
wherein each PDSCH group of the plurality of PDSCH groups is associated with a respective HARQ acknowledgement (HARQ-ACK) codebook, and
wherein each priority level of a plurality of priority levels corresponds to respective two PDSCH groups of the plurality of PDSCH groups.

19. The method of claim 18, wherein a number of PDSCH groups in the plurality of PDSCH groups is configured by radio resource control (RRC) signaling or specified per HARQ-ACK codebook priority.

20. The method of claim 18, wherein a respective priority of each PDSCH group of the plurality of PDSCH groups is determined based on:
a priority of an associated HARQ codebook; or
a priority of a downlink control information (DCI) signaling that schedules the respective PDSCH group; or
an assigned priority for the respective PDSCH group; or
a separately configured priority for the respective PDSCH group.
